(19) United States
(12) Patent Application Publication
(10) Pub. No.: US 2014/0105021 A1
(43) Pub. Date: Apr. 17, 2014

(54) APPARATUS AND METHOD FOR ESTIMATING NETWORK MAXIMUM DELAY, AND APPARATUS AND METHOD FOR CONTROLLING NETWORK ADMISSION

(71) Applicant: ELECTRONICS AND TELECOMMUNICATIONS RESEARCH INSTITUTE, Daejeon-si (KR)

(72) Inventors: Jeong-Yun KIM, Daejeon-si (KR); Jinoo JOUNG, Seoul (KR)

(73) Assignee: ELECTRONICS AND TELECOMMUNICATIONS RESEARCH INSTITUTE, Daejeon-si (KR)

(21) Appl. No.: 14/047,473

(22) Filed: Oct. 7, 2013

(30) Foreign Application Priority Data
Oct. 11, 2012 (KR) 10-2012-0112856

(51) Int. Cl. H04L 12/927; H04L 12/841; H04L 12/26

(52) U.S. Cl. CPC H04L 47/805; H04L 43/0852; H04L 47/283
USPC 370/235; 370/252

(57) ABSTRACT

Disclosed are an apparatus and method for estimating network maximum delay. The method of estimating network maximum delay may include: estimating first maximum delay using a first parameter caused from a flow and a second parameter caused from a network; estimating second maximum delay using a probability distribution based on packet delay information about the flow admitted to the network; and estimating a mixed maximum delay by mixing the first maximum delay and the second maximum delay.

### CROSS-REFERENCE TO RELATED APPLICATION

This application claims the benefit under 35 U.S.C. §119(a) of Korean Patent Application No. 10-2012-0112856, filed on Oct. 11, 2012, the entire disclosure of which is incorporated herein by reference for all purposes.

### BACKGROUND

1. Field

The present invention relates to a network technology, and more particularly, to an apparatus and method for estimating network maximum delay.

2. Description of the Background

With the advance of the Internet, users require a variety of services and also high Quality of Service (QoS), which lead to the explosive growth of new multimedia services that require a high bandwidth and quality. Thus, a QoS guarantee technology that can efficiently utilize an existing network and individually apply to a variety of services is needed.

One of several technical elements for QoS guarantee is network performance measurement for quality guarantee. On the basis of the accurate network performance measurement, it is possible to accurately guarantee network quality requirements and check current network conditions. A method of measuring a network delay time related to the network performance may include a method of calculating the network delay time on the basis of network parameters or a method of directly measuring a packet delay time. However, the method of calculating the network delay time on the basis of network parameters has a limitation in that a maximum delay time is estimated to be too high, and the method of directly measuring a packet delay time has a limitation in terms of measurement inaccuracy and environmental constraints.

### SUMMARY

The present invention provides an apparatus and method for estimating network maximum delay, which can accurately estimate the maximum delay at a high rate by mixing the method of estimating the parameter-based maximum delay and the method of estimating the measurement-based maximum delay.

The present invention also provides an apparatus and method for controlling network flow admission, which can increase accuracy in admission control and efficiently use the network.

In a general aspect, the method of estimating network maximum delay may include: estimating first maximum delay using a first parameter caused from a flow and a second parameter caused from a network; estimating second maximum delay using a probability distribution based on packet delay information about the flow admitted to the network; and estimating a mixed maximum delay by mixing the first maximum delay and the second maximum delay.

In another general aspect, the apparatus for estimating network maximum delay may include: a first estimation unit configured to estimate first maximum delay using a first parameter caused from a flow and a second parameter caused from a network; a second estimation unit configured to estimate second maximum delay using a probability distribution based on packet delay information about the flow admitted to the network; and a mixing estimation unit configured to estimate a mixed maximum delay by mixing the first maximum delay and the second maximum delay.

In still another general aspect, the method of controlling network flow admission may include: estimating first maximum delay using a first parameter caused from a flow and a second parameter caused from a network; estimating second maximum delay using a probability distribution based on packet delay information about the flow admitted to the network; estimating a mixed maximum delay by using the first maximum delay and the second maximum delay; and determining whether to allow the admission of the flow using the first maximum delay and the mixed maximum delay.

Other features and aspects will be apparent from the following detailed description, the drawings, and the claims.

### BRIEF DESCRIPTION OF THE DRAWINGS

FIG. 1 is a block diagram showing an apparatus for estimating network maximum delay according to an embodiment of the present invention.

FIG. 2 is a detailed block diagram showing a second estimation unit 130 of FIG. 1.

FIG. 3 is a flowchart illustrating a method of estimating network maximum delay according to an embodiment of the present invention.

FIG. 4 is a detailed flowchart illustrating operation 310 of estimating the parameter-based maximum delay of FIG. 3.

FIG. 5 is a detailed flowchart illustrating operation 320 of estimating the measurement-based maximum delay of FIG. 3.

FIG. 6 is a block diagram showing an apparatus for controlling network flow admission including an apparatus for estimating network maximum delay according to an embodiment of the present invention.

FIG. 7 is a flowchart illustrating a method of controlling network flow admission according to another embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Also, the terms described below are defined with consideration of the functions in the present invention, and thus may vary depending on intention of a user or an operator, or custom. Accordingly, the definition would be made on the basis of the whole specification.

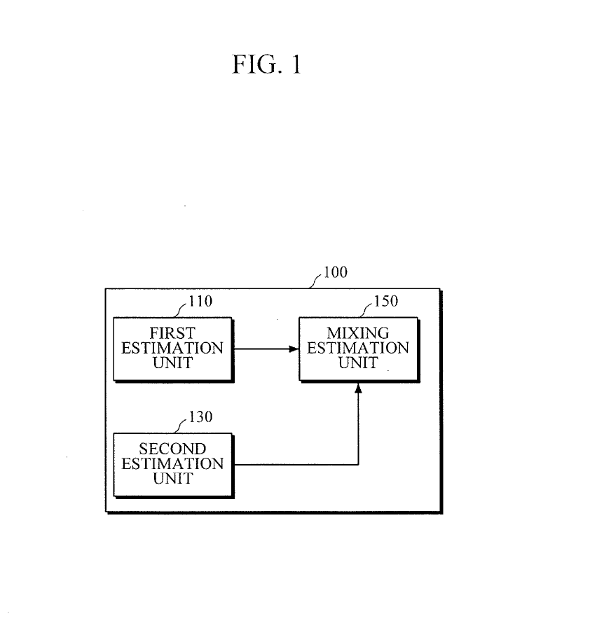

FIG. 1 is a block diagram showing an apparatus for estimating network maximum delay according to an embodiment of the present invention.

Referring to FIG. 1, the apparatus for estimating network maximum delay 100 may include a first estimation unit 110, a second estimation unit 130, and a mixing estimation unit 150.

The first estimation unit 110 may estimate a parameter-based maximum delay using flow information and network information. In this case, the flow information indicates a burst size, a sustainable bit rate, etc. of a flow that requests admission, and the network information indicates latency in an aggregation region of a network. Here, the aggregation region is a region where the flow is integrated or separated.

For example, delay D, of flow i may be calculated using Equation (1).

$${D}_{i} \leq \frac{{σ}_{i}}{{ρ}_{i}} + {\sum }_{m = 1}^{M} {θ}_{i}^{{AR}^{m}} \qquad ( 1 )$$

where θᵢ^{AR}^{^{m}} is latency in an m-th aggregation region AR^{m} of flow i, σᵢ is a burst size of flow i, and ρᵢ is a sustainable bit rate of flow i. Accordingly, the parameter-based maximum delay of flow i may be estimated by calculating delay Dᵢ of flow i using Equation (1).

The second estimation unit 130 may estimate a measurement-based maximum delay by collecting delay information about a packet of a flow admitted to a network. In this case, the probability distribution may be gamma distribution, but it is not limited thereto. The probability distribution may include a variety of probability distributions such as Weibull distribution, Poisson distribution, etc.

The mixing estimation unit 150 may estimate a mixed maximum delay by mixing the parameter-based maximum delay estimated by the first estimation unit 110 with the measurement-based maximum delay estimated by the second estimation unit 130. For example, the mixing estimation unit 150 may calculate weights (or application rates) applied to the parameter-based maximum delay and the measurement-based maximum delay and apply the calculated weights (or application rates) to the parameter-based maximum delay and the measurement-based maximum delay, respectively, to estimate the mixed maximum delay.

In this case, the mixing estimation unit 150 may use accuracy in the measurement-based maximum delay when calculating the weights (or application rates). As more delay information is used to calculate a probability distribution, the probability distribution is more accurate. Thus, as more delay information is collected, the measurement-based maximum delay has a more accurate value. Accordingly, a greater weight (or application rate) is applied to the measurement-based maximum delay as more delay information is collected, and a greater weight (or application rate) is applied to the parameter-based maximum delay as less delay information is collected.

Suppose that the accuracy in the measurement-based maximum delay has a value of 0 to 1. If the accuracy in the measurement-based maximum delay determined on the basis of the number of collected delay information pieces is 1, the mixed maximum delay is estimated by applying 100% to the measurement-based maximum delay and applying 0% to the parameter-based maximum delay (that is, the measurement-based maximum delay is equal to the mixed maximum delay). If the accuracy in the measurement-based maximum delay is 0, the mixed maximum delay is estimated by applying 0% to the measurement-based maximum delay and applying 100% to the parameter-based maximum delay (that is, the parameter-based maximum delay is equal to the mixed maximum delay). In this case, information about the relation between the number of collected delay information pieces and the accuracy in the measurement-based maximum delay may be previously stored in the mixing estimation unit 150 and may be received from the outside or entered by a user.

The mixing estimation unit 150 has been described to calculate the weights (or application rates), but the weights may be entered by a user. In this case, the mixing estimation unit 150 should calculate the mixed maximum delay by applying only the weights (or application rates) entered by the user.

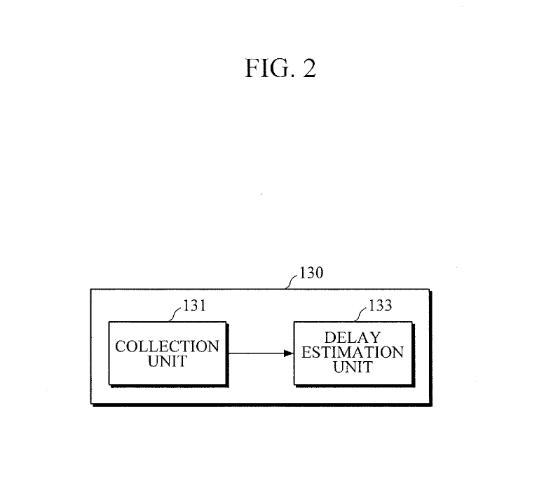

FIG. 2 is a detailed block diagram showing the second estimation unit 130 of FIG. 1.

Referring to FIG. 2, the second estimation unit 130 may include a collection unit 131 and a delay estimation unit 133.

The collection unit 131 may collect delay information about a packet of a flow admitted to a network. The collection unit 131 may directly measure packet delay or receive previously measured packet delay information from a user in order to collect the packet delay information. In this case, the delay information includes information on the number of packets, information about delay distribution of the packets, etc.

The delay estimation unit 133 may calculate the probability distribution on the basis of the delay information collected by the collection unit 131, and estimate the measurement-based maximum delay from the calculated probability distribution. In this case, the probability distribution may be gamma distribution, but it is not limited thereto. The probability distribution may include a variety of probability distributions such as Weibull distribution, Poisson distribution, etc.

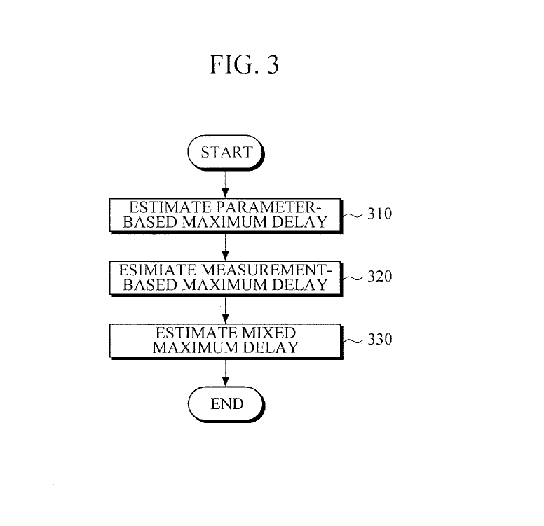

FIG. 3 is a flowchart illustrating a method of estimating network maximum delay according to an embodiment of the present invention.

Referring to FIG. 3, the method of estimating the network maximum delay according to an embodiment of the present invention includes estimating a parameter-based maximum delay using flow information and network information (310). In this case, the flow information indicates a burst size, a sustainable bit rate, etc. of a flow that requests admission, and the network information indicates latency in an aggregation region of a network. Here, the aggregation region is a region where the flow is integrated or separated.

For example, the parameter-based maximum delay of the flow may be estimated using Equation (1).

Then, the method includes estimating a measurement-based maximum delay by calculating a probability distribution on the basis of packet delay information (320). In this case, the packet delay information is delay information about a packet of a flow admitted to a network and includes information about the number of packets, information about delay distribution of the packets, etc. Also, the probability distribution may be gamma distribution, but it is not limited thereto. The probability distribution may include a variety of probability distributions such as Weibull distribution, Poisson distribution, etc.

Then, the method include estimating a mixed maximum delay by mixing the parameter-based maximum delay estimated in operation 310 with the measurement-based maximum delay estimated in operation 320. In this case, the mixed maximum delay may be estimated by calculating weights (or application rates) applied to the parameter-based maximum delay and the measurement-based maximum delay and then applying the calculated weights (or application rates) to the parameter-based maximum delay and the measurement-based maximum delay, respectively.

In this case, the weights may be entered by a user and calculated in operation 330. If the weights are calculated in operation 330, accuracy in the measurement-based maximum delay may be used. As more delay information is used to calculate a probability distribution, the probability distribution is more accurate. Thus, as more delay information is collected, the measurement-based maximum delay has a more accurate value. Accordingly, a greater weight (or application rate) is applied to the measurement-based maximum delay as more delay information is collected, and a greater weight (or application rate) is applied to the parameter-based maximum delay as less delay information is collected.

Suppose that the accuracy in the measurement-based maximum delay has a value of 0 to 1. If the accuracy in the measurement-based maximum delay determined on the basis of the number of collected delay information pieces is 1, the mixed maximum delay is estimated by applying 100% to the measurement-based maximum delay and applying 0% to the parameter-based maximum delay (that is, the measurement-based maximum delay is equal to the mixed maximum delay). If the accuracy in the measurement-based maximum delay is 0, the mixed maximum delay is estimated by applying 0% to the measurement-based maximum delay and applying 100% to the parameter-based maximum delay (that is, the parameter-based maximum delay is equal to the mixed maximum delay). In this case, information about the relation between the number of collected delay information pieces and the accuracy in the measurement-based maximum delay may be previously stored in the mixing estimation unit 150 and may be received from the outside or entered from a user.

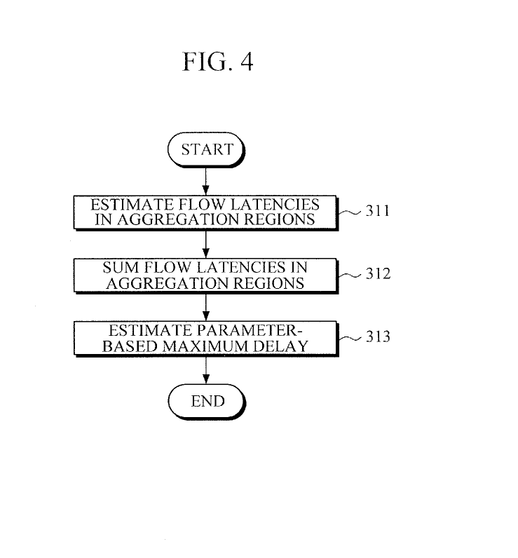

FIG. 4 is a detailed flowchart illustrating the estimating of the parameter-based maximum delay (310) of FIG. 3.

As shown in FIG. 4, operation 310 includes estimating flow latencies in aggregation regions (ARs) of a network (311). Then, operation 310 includes summing the estimated flow latencies in the aggregation regions (312) and estimating the parameter-based maximum delay using the summed flow latency and a burst size and sustainable bit rate of the flow (313).

For example, the parameter-based maximum delay of the flow may be estimated using Equation (1).

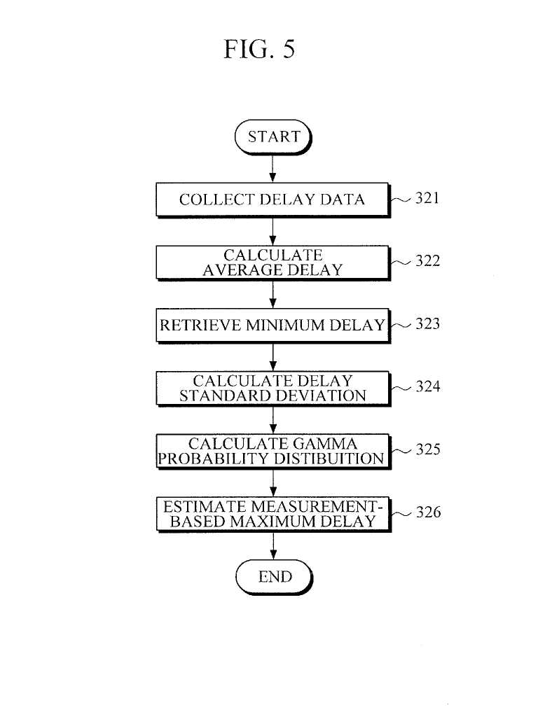

FIG. 5 is a detailed flowchart illustrating the estimating of the measurement-based maximum delay (320) of FIG. 3.

Referring to FIG. 5, operation 320 includes collecting packet delay data of a flow admitted to a network (321). In this case, it is possible to directly measure packet delay or simply receive previously measured packet delay data in order to collect the packet delay data.

Then, operation 320 includes calculating an average delay using the collected delay data (322) and retrieving minimum delay from among the collected delay data (323).

Then, operation 320 includes calculating a standard deviation of the collected delay data (324) and calculating gamma probability distribution on the basis of the average delay, the minimum delay, and the standard deviation (325). In this case, the probability distribution may be gamma probability distribution, but it is not limited thereto. The probability distribution may include a variety of probability distributions such as Weibull distribution, Poisson distribution, etc.

Then, operation 320 includes estimating the measurement-based maximum delay using the calculated gamma probability distribution (326).

In the method of estimating the measurement-based maximum delay (320), operations 322 to 324 have been described to be sequentially performed, but not necessarily. That is, any one of operations 322 to 324 may be first performed and then the others can be performed. Also, operations 322 to 324 may be simultaneously performed. Also, in the method of estimating the measurement-based maximum delay (320), operations 321 to 324 may be omitted, and operations 325 and 326 may be performed by receiving the delay information from a user to use the delay information.

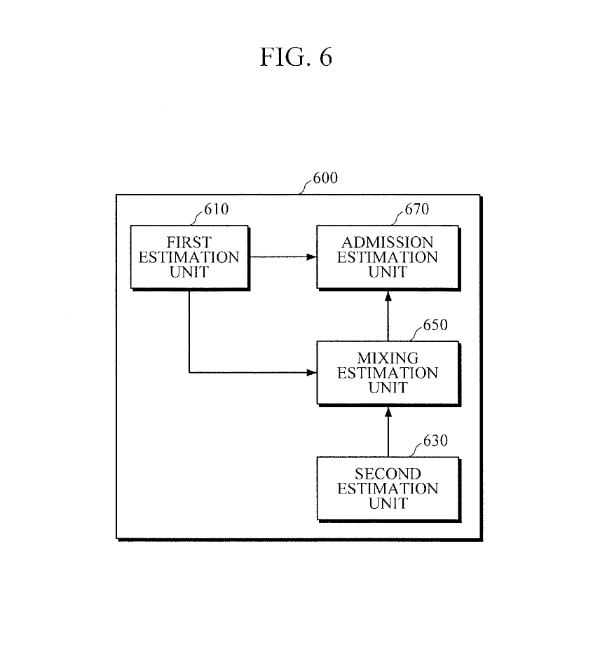

FIG. 6 is a block diagram showing an apparatus for controlling network flow admission including an apparatus for estimating network maximum delay according to an embodiment of the present invention.

Referring to FIG. 6, the apparatus for controlling network flow admission 600 may include a first estimation unit 610, a second estimation unit 630, a mixing estimation unit 650, and an admission determination unit 670. Here, the first estimation unit 610, the second estimation unit 630, and the mixing estimation unit 650 have the same configurations as those of the apparatus for estimating network maximum delay 100 shown in FIG. 1, respectively. Accordingly, descriptions thereof will be omitted.

The admission determination unit 670 may determine whether to allow admission of a flow that requests admission according to the presence of QoS guarantee, using the parameter-based maximum delay estimated by the first estimation unit 610 and the mixed maximum delay estimated by the mixing estimation unit 650.

For example, if there is no flow admitted to the network and the second estimation unit 630 cannot collect delay information, the admission determination unit 670 determines whether to allow admission of the flow that requests the admission, using only the parameter-based maximum delay calculated by the first estimation unit 610. In this case, the admission is allowed if the maximum delay required by the flow that requests admission is greater than the parameter-based maximum delay estimated by the first estimation unit 610, and the admission is disallowed if the maximum delay required by the flow that requests admission is less than the parameter-based maximum delay estimated by the first estimation unit 610.

If there is any flow admitted to the network and the second estimation unit 630 can collect delay information, the admission determination unit 670 determines whether to allow admission of the flow that requests the admission, using only the mixed maximum delay estimated by the mixing estimation unit 650. In this case, the admission is allowed if the maximum delay required by the flow that requests admission is greater than the mixed maximum delay estimated by the mixing estimation unit 650, and the admission is disallowed if the maximum delay required by the flow that requests admission is less than the mixed maximum delay estimated by the mixing estimation unit 650.

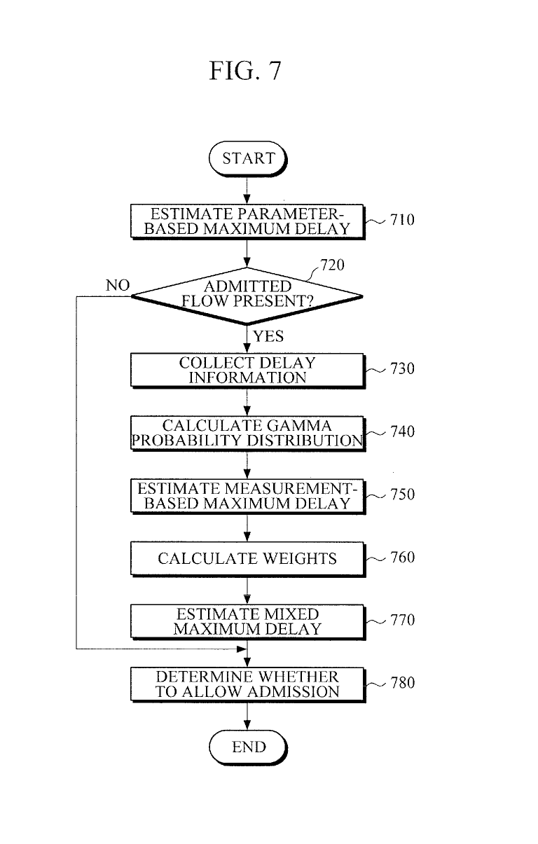

FIG. 7 is a flowchart illustrating a method of controlling network flow admission according to another embodiment of the present invention.

Referring to FIG. 7, the method of controlling network flow admission includes estimating a parameter-based maximum delay using flow information and network information (710).

In this case, the flow information indicates a burst size, a sustainable bit rate, etc. of a flow that requests admission, and the network information indicates latency in an aggregation region of a network. Here, the aggregation region is a region where the flow is integrated or separated.

For example, the parameter-based maximum delay of the flow may be estimated using Equation (1).

Then, the method includes determining the presence of the flow admitted to the network (720).

The method includes collecting packet delay information about the admitted flow when the admitted flow is determined to be present in operation 720. In this case, the delay information collection may be performed on all packets, or only packets sampled according to a predetermined criterion.

Then, the method includes calculating gamma probability distribution using the collected delay information (740). In this case, the probability distribution may be gamma probability distribution, but it is not limited thereto. The probability distribution may include a variety of probability distributions such as Weibull distribution, Poisson distribution, etc.

Then, the method includes estimating the measurement-based maximum delay using the calculated gamma probability distribution (750).

Then, the method includes calculating a weight (or application rate) to be applied when estimating the mixed maximum delay (760) and estimating the mixed maximum delay using the parameter-based maximum delay, the measurement-based maximum delay, and the weight (or application rate) (770).

When the weight (or application rate) is calculated, accuracy in the measurement-based maximum delay may be used. As more delay information is used to calculate a probability distribution, the probability distribution is more accurate. Thus, as more delay information is collected, the measurement-based maximum delay has a more accurate value. Accordingly, the mixed maximum delay is estimated by applying a greater weight (or application rate) to the measurement-based maximum delay as more delay information is collected, and applying a greater weight (or application rate) to the parameter-based maximum delay as less delay information is collected.

Suppose that the accuracy in the measurement-based maximum delay has a value of 0 to 1. If the accuracy in the measurement-based maximum delay determined on the basis of the number of collected delay information pieces is 1, the mixed maximum delay is estimated by applying 100% to the measurement-based maximum delay and applying 0% to the parameter-based maximum delay (that is, the measurement-based maximum delay is equal to the mixed maximum delay). If the accuracy in the measurement-based maximum delay is 0, the mixed maximum delay is estimated by applying 0% to the measurement-based maximum delay and applying 100% to the parameter-based maximum delay (that is, the parameter-based maximum delay is equal to the mixed maximum delay).

Then, the method includes determining whether to allow the admission of the flow according to the presence of QoS guarantee, using the estimated mixed maximum delay. For example, the admission is allowed if the maximum delay required by the flow that requests admission is greater than the estimated mixed maximum delay, and the admission is disallowed if the maximum delay required by the flow that requests admission is less than the estimated mixed maximum delay.

If no flow admitted to the network is determined to be present in operation 720, the delay information about the packet of the flow admitted to the network may not be collected, and thus the measurement-based maximum delay may not be estimated. Accordingly, the method includes determining whether to allow the admission of the flow using the parameter-based maximum delay estimated in operation 710 (780). For example, the admission is allowed if the maximum delay required by the flow that requests admission is greater than the estimated parameter-based maximum delay, and the admission is disallowed if the maximum delay required by the flow that requests admission is less than the estimated parameter-based maximum delay.

This invention has been particularly shown and described with reference to preferred embodiments thereof. It will be understood by those skilled in the art that various changes in form and details may be made therein without departing from the spirit and scope of the invention as defined by the appended claims. Therefore, the scope of the invention is defined not by the detailed description of the invention but by the appended claims, and a variety of embodiments within the scope will be construed as being included in the present invention.

What is claimed is:

1. A method of estimating network maximum delay comprising:
estimating first maximum delay using a first parameter caused from a flow and a second parameter caused from a network;
estimating second maximum delay using a probability distribution based on packet delay information about the flow admitted to the network; and
estimating a mixed maximum delay by mixing the first maximum delay and the second maximum delay.

2. The method of claim 1, wherein the first parameter indicates a burst size and a sustainable bit rate of the flow, and
the second parameter indicates latency in an aggregation region of the network.

3. The method of claim 1, wherein the packet delay information comprises packet number information and packet delay distribution information.

4. The method of claim 1, wherein the estimating of the second maximum delay comprises estimating the second maximum delay using gamma probability distribution.

5. The method of claim 1, wherein the estimating of the mixed maximum delay comprises:
calculating weights to be used to estimate the mixed maximum delay; and
estimating mixed maximum delay by applying the calculated weights to the first maximum delay and the second maximum delay, respectively.

6. The method of claim 5, wherein the calculating of weights comprises calculating the weights using accuracy in the second maximum delay.

7. An apparatus for estimating network maximum delay comprising:
a first estimation unit configured to estimate first maximum delay using a first parameter caused from a flow and a second parameter caused from a network;
a second estimation unit configured to estimate second maximum delay using a probability distribution based on packet delay information about the flow admitted to the network; and
a mixing estimation unit configured to estimate a mixed maximum delay by mixing the first maximum delay and the second maximum delay.

8. The apparatus of claim 7, wherein the first parameter indicates a burst size and a sustainable bit rate of the flow, and
the second parameter indicates latency in an aggregation region of the network.

9. The apparatus of claim 7, wherein the packet delay information comprises packet number information and packet delay distribution information.

10. The apparatus of claim 7, wherein the second estimation unit estimates the second maximum delay using gamma probability distribution.

11. The apparatus of claim 7, wherein the mixing estimation unit calculates weights to be used to calculate the mixed maximum delay and estimates the mixed maximum delay by applying the calculated weights to the first maximum delay and the second maximum delay, respectively.

12. The apparatus of claim 11, wherein the mixing estimation unit calculates the weights using accuracy in the second maximum delay.

13. A method of controlling network flow admission comprising:
estimating first maximum delay using a first parameter caused from a flow and a second parameter caused from a network;
estimating second maximum delay using a probability distribution based on packet delay information about the flow admitted to the network;
estimating a mixed maximum delay by mixing the first maximum delay and the second maximum delay; and
determining whether to allow the admission of the flow using the first maximum delay and the mixed maximum delay.

14. The method of claim 13, wherein the estimating of the second maximum delay comprises estimating the second maximum delay using gamma probability distribution.

15. The method of claim 13, wherein the determining of whether to allow the admission of the flow comprises determining whether to allow the admission of the flow according to the presence of Quality of Service (QoS) guarantee using the first maximum delay and the mixed maximum delay.

16. The method of claim 13, wherein the estimating of the second maximum delay comprises:
collecting packet delay information about the flow admitted to the network;
calculating a probability distribution using the collected packet delay information; and
estimating the second maximum delay using the calculated probability distribution.
